(19) United States
(12) Patent Application Publication
(10) Pub. No.: US 2026/0296794 A1
(43) Pub. Date: Oct. 1, 2026

(54) Pre-depolymerization Hollow Shaft Feed Screw

(71) Applicants: Anthony Manis, LaFayette, GA (US); David Kelley, Knoxville, TN (US)

(72) Inventors: David Kelley, Knoxville, TN (US); Anthony Manis, LaFayette, GA (US)

(21) Appl. No.: 19/542,933

(22) Filed: Feb. 18, 2026

Related U.S. Application Data
(60) Provisional application No. 63/759,679, filed on Feb. 18, 2025.

(51) Int. Cl. B65G 33/14; C08J 11/14

(52) U.S. Cl. CPC B65G 33/14; C08J 11/14; C08J 2323/12; C08J 2333/24; C08J 2367/03

(57) ABSTRACT

A pre-depolymerization hollow shaft feed screw for feeding a material in a depolymerization process is disclosed. An auger is received within an auger housing and is configured to rotate to convey material along the auger housing to a compression zone, the auger having a hollow central shaft. An insulation material is provided along an interior of the hollow central shaft of the auger, and a pump is configured to convey a high-temperature depolymerization fluid along the hollow central shaft of the auger to the compression zone. The insulation material limits heat transfer from the depolymerization fluid to the auger and to the material while the depolymerization fluid and the material are conveyed to the compression zone, thereby enabling early contact between the material and the depolymerization fluid without requiring pelletization or extensive screening of the material.

### CROSS-REFERENCE TO RELATED APPLICATIONS

This Application claims the benefit of U.S. Provisional Patent Application Ser. No. 63/759,679, filed on Feb. 18, 2025, the content of which is incorporated herein in its entirety by reference.

### STATEMENT REGARDING FEDERALLY SPONSORED RESEARCH OR DEVELOPMENT

Not Applicable.

### FIELD OF INVENTION

The present general inventive concept pertains to polymer recycling, and more particularly to a device for feeding recyclable polymer material for depolymerization.

### BACKGROUND

Polyester and other polymer resins are widely used in packaging and consumer products and can be chemically recycled via depolymerization back to monomers or other useful intermediates. Conventional depolymerization processes typically receive an initial feed comprising a mixture of materials, such as polymer flakes, pellets, chunks, and fines, that has been size-reduced by shredding, grinding, hammermilling, or similar operations. These size-reduction steps create dust and fines that tend to become airborne during separation and conveyance, posing safety, housekeeping, and maintenance concerns and often requiring additional shaking, screening, and air-handling equipment.

In traditional systems, mixed polymer feed stocks are frequently pelletized or otherwise conditioned before being introduced into depolymerization reactors, which adds capital cost, energy consumption, and process complexity. There is thus a need for systems and methods that can convey mixed polymer materials—including dust and fines—while initiating contact with a depolymerization fluid, without the need to pelletize or extensively screen the material, and while controlling heat transfer so that the material does not prematurely melt and foul conveying equipment.

### BRIEF SUMMARY OF THE INVENTION

The present general inventive concept solves the problem of moving many different types of materials in a single step. Pellets, large chunks, dust and flakes can be transferred in this process. Various example embodiments of the present general inventive concept may be used at the start of a depolymerization process, thus increasing thruput in depolymerization systems. Material that is shredded, hammermilled, crushed and extruded can be moved without having to be separated by moving material using devices and methods constructed in accordance with the present general inventive concept. There's no need to pelletize the material. This can potentially result in huge savings, by as much as 0.15 to 0.30 cents per pound, over a conventional depolymerization process and method. That cost alone is the difference between making a profit or not, for most depolymerization processes. The present general inventive concept also eliminates the need to shake or screen material to remove dust and reduces the cost by several cents per pound.

According to various example embodiments of the present general inventive concept, an improved process of moving materials that are mixed is provided. The mixed materials do not need to be screened or pelletized. The present general inventive concept also increases thruput in depolymerization systems by transferring material in early contact with the breakdown fluid. Many types of polymers, including polyethylene terephthalate (“PET”), nylon, and polypropylene (“PP”), may benefit from this inventive concept.

In one aspect, a pre-depolymerization hollow shaft feed screw is provided for feeding a material in a depolymerization process. An auger is received within an auger housing and is configured to rotate to convey material along the auger housing to a compression zone, the auger having a hollow central shaft. An insulation material is provided along an interior of the hollow central shaft, and a pump is configured to convey a high-temperature depolymerization fluid along the hollow central shaft of the auger to the compression zone, with the insulation material limiting heat transfer from the depolymerization fluid to the auger and material while both are conveyed to the compression zone.

In another aspect, a hollow shaft feed screw is provided for conveying mixed materials, such as polymer resins and foams, with a fluid while controlling heat transfer and enabling early contact between the material and a breakdown or depolymerization fluid. In some embodiments, air removal systems, jacketed pipes or electric heating bands, and cooling media along the shaft interior or rotary union are used to manage temperature and reduce entrained air in the depolymerization fluid. The system can reduce or eliminate pelletizing, screening, and dust-handling operations while increasing throughput and improving metering precision.

Additional aspects and advantages of the present general inventive concept will be set forth in part in the description which follows, and, in part, will be obvious from the description, or may be learned by practice of the present general inventive concept.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 illustrates a schematic side view, in cross-section, of a pre-depolymerization hollow shaft feed screw including an auger within an auger housing, a hollow central shaft, insulation, a depolymerization fluid path, a hopper, a compression zone, and associated drive and pump components, each constructed according to an example embodiment of the present general inventive concept;

FIG. 2 is an enlarged cross-sectional view taken through the auger and hollow central shaft, illustrating insulation along the interior of the hollow shaft and a fluid passage for conveying high-temperature depolymerization fluid;

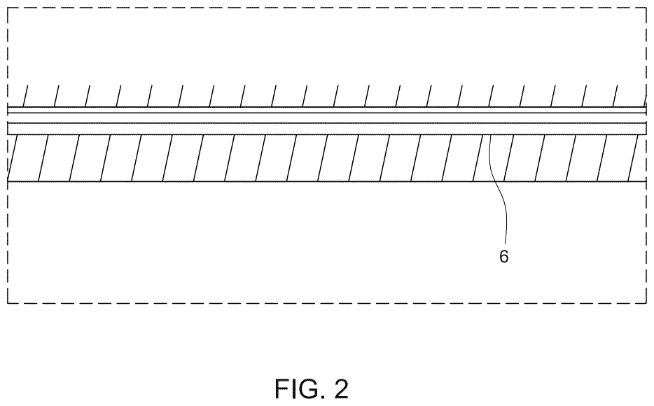

FIG. 3 is a schematic view of a high-heat rotary union coupled to the hollow central shaft and to a fluid supply line, showing optional coolant paths and seals; and

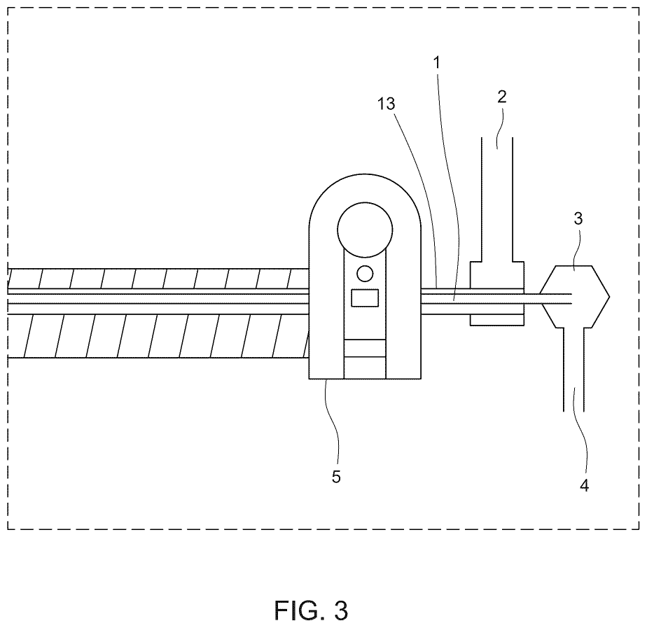

FIG. 4 is a perspective or sectional view of the auger housing showing stops mounted on interior sidewalls, a compression zone, and optional jacketed pipe or electric heating bands surrounding the housing.

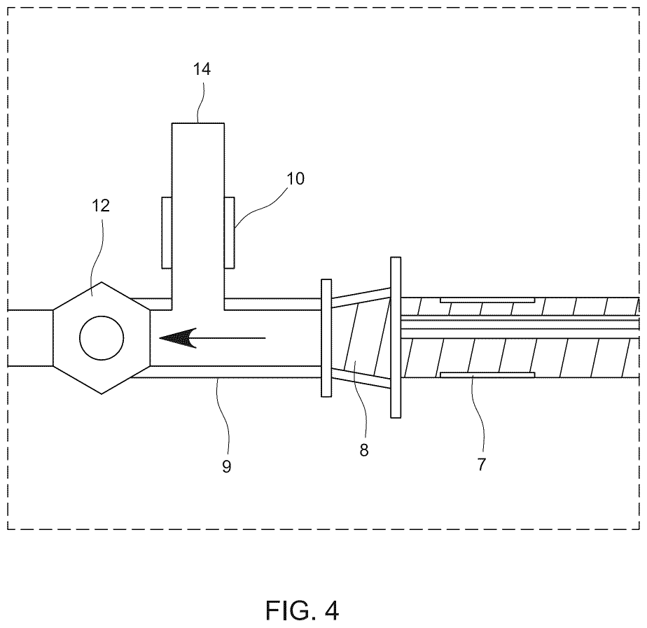

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

According to various example embodiments of the present general inventive concept, a pre-depolymerization hollow shaft feed screw is provided that allows for the transport of mixed material including polymer resin material for depolymerization. The pre-depolymerization hollow shaft feed screw, or “feed screw,” is capable of exposing the mixed material to a pre-depolymerization fluid while being transported through the screw. Thus, the feed screw is capable of converting the mixed material into a feed material for further depolymerization absent the need to pelletize, shake, or screen the material.

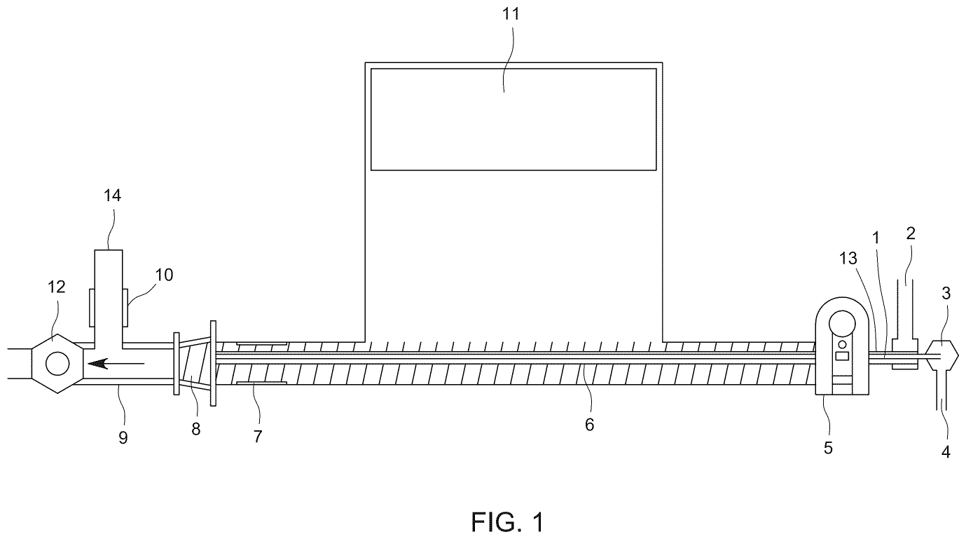

In some embodiments, as shown in FIG. 1, a pre-depolymerization hollow shaft feed screw includes an auger 6 received within an auger housing and driven by a pass-through gearbox and motor 5 to rotate about a central axis. The auger 6 has a hollow central shaft 1 that defines a fluid passage extending along at least a portion of the length of the auger from an inlet region proximate a drive end to an outlet region proximate a compression zone 8. Material, such as mixed polymer feed consisting of pellets, large chunks, dust, flakes, and other particulates, is introduced through a hopper 11 and is conveyed along the auger housing toward the compression zone 8 as the auger 6 rotates.

A pump 12 is configured to convey a high-temperature depolymerization fluid 4 through a high-heat rotary union 3 and into the hollow central shaft 1. The depolymerization fluid may comprise an aqueous solution or other breakdown fluid selected for chemical interaction with the polymer material. The fluid 4 flows along the hollow shaft 1 and exits into the compression zone 8, where it contacts material conveyed by the auger 6. The compression zone 8 can be configured to apply axial compression to the material, and may include reduced pitch flights, flow restrictions, or other features to increase residence time and promote wetting by the depolymerization fluid.

An insulation material 13 is provided along an interior of the hollow central shaft 1, between the depolymerization fluid 4 and the shaft wall, to limit heat transfer from the high-temperature fluid to the auger 6 and the material conveyed therein. In some embodiments, the insulation material 13 comprises a thermal insulation layer, an air gap, or a rotary union feature 2 in combination with air, water, or oil acting as a coolant. By limiting heat transfer, the system reduces the risk of premature melting of polymer material and adhesion to the auger surfaces, thereby maintaining conveying efficiency and reducing fouling.

The auger housing may include one or more stops 7 mounted on interior sidewalls of the auger housing to reduce or prevent rotation of conveyed material with the auger 6 and to promote mixing and axial conveyance. Jacketed pipe 9 surrounding the housing or electric heating bands 10 may be provided to control the temperature of the depolymerization fluid and the material in selected regions, such as near the compression zone 8 or outlet. An air removal system 14 can be fluidly coupled to the depolymerization fluid circuit to remove entrained or trapped air from the fluid 4 prior to or during passage along the hollow shaft 1, which can improve thermal transfer characteristics and process stability.

In some embodiments, the pre-depolymerization hollow shaft feed screw is positioned upstream of a depolymerization reactor such that depolymerization can begin at or near the feed-screw exit in a downstream pipe or reactor inlet. The combination of controlled fluid delivery through the hollow shaft, limited heat transfer via insulation, and compression-zone mixing enables early and controlled contact between the polymer material and the depolymerization fluid without requiring the material to be pelletized or separately screened for dust. Mixed material streams that include dust and fines can thus be conveyed and processed in a single step, reducing equipment and operating costs and improving throughput.

The system can be configured to process various polymers, including polyethylene terephthalate (PET), nylon, polypropylene (PP), and other thermoplastic materials. In some embodiments, the hollow shaft feed screw is used to convey and pre-treat open or closed cell foams, either as a substantially foam-only feed or as a mixture of foam with other materials, by compressing and transporting the foam through the auger housing to a processing apparatus.

In operation, material may be loaded into the hopper 11 as the auger turns 6 by the pass thru gearbox and motor 5. The auger may have a hollow shaft 1 that transfers fluid 4. It is pumped through a high heat rotary union 3 to keep the material from melting due to the high temperature of the depolymerization fluid 4. The auger 6 may be is coated inside by insulation 13 or rotary union 2 with air, water and/or oil acting as a coolant to keep material from melting and adhering to the outside of the auger. As the material moves down the auger 6 it is forced into the compression zone 8 to keep material from spinning. Several stops 7 may be mounted on the side walls of the auger 6. Jacketed pipe 9 or electric heating bands 10 may be used as additional heat. An air removal system 14 can be used to remove air trapped in the depolymerization fluid 4. The pump 12 can be used to assist flow.

From the foregoing, it will be recognized by one of skill in the art that the pre-depolymerization can take place at the feed screw exit of material in a pipe. Aqueous solution can be passed through a hollow shaft feed screw to convey material in depolymerization. Metering and feeding material is more precise. Nylon, PET, PP and other polymers can utilize this process.

It will further be recognized by one of ordinary skill in the art that a hollow shaft feed screw constructed in accordance with several aspects and features of the present general inventive concept may be used to convey other types of materials for recycling-based processing. For example, it will be recognized that the hollow shaft feed screw may be used to convey various types of open and/or closed cell foam, either in a relatively pure feed source or in a feed source mixed with other materials. In one example embodiment, material comprising open and closed cell foam is compressed and conveyed using the hollow shaft feed screw. Thus, the foam may be transported using the hollow shaft feed screw to any of various apparatus for processing.

Numerous variations are possible. For example, the auger geometry, housing cross-section, compression-zone design, insulation composition, rotary union configuration, and fluid type and temperature can be varied to suit particular materials and depolymerization chemistries. Multiple feed screws can be arranged in series or parallel, and control systems can be implemented to coordinate auger speed, pump rate, and heating or cooling inputs for precise metering and process control.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment. Numerous variations, modification, and additional embodiments are possible, and, accordingly, all such variations, modifications, and embodiments are to be regarded as being within the spirit and scope of the present general inventive concept.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. A pre-depolymerization hollow shaft feed screw for feeding a material in a depolymerization process, comprising:
an auger received within an auger housing and configured to rotate to convey material along the auger housing to a compression zone, the auger having a hollow central shaft;
an insulation material along an interior of the hollow central shaft of the auger; and
a pump configured to convey a high-temperature depolymerization fluid along the hollow central shaft of the auger to the compression zone;
wherein the insulation material limits heat transfer from the depolymerization fluid to the auger and to the material while the depolymerization fluid and the material are conveyed to the compression zone.

2. The feed screw of claim 1, wherein the depolymerization fluid comprises an aqueous solution configured to chemically break down a polymer contained in the material.

3. The feed screw of claim 1, wherein the material comprises one or more polymers selected from the group consisting of polyethylene terephthalate, nylon, and polypropylene.

4. The feed screw of claim 1, wherein the material comprises a mixture of particles having different sizes including at least one of pellets, chunks, flakes, dust, and fines.

5. The feed screw of claim 1, wherein the auger housing includes a plurality of stops mounted on interior sidewalls of the auger housing to inhibit rotation of the material with the auger and to promote axial conveyance and mixing.

6. The feed screw of claim 1, further comprising a high-heat rotary union fluidly coupled between the pump and the hollow central shaft to deliver the depolymerization fluid to the hollow central shaft while accommodating rotation of the auger.

7. The feed screw of claim 1, further comprising at least one of a jacketed pipe surrounding the auger housing and an electric heating band configured to selectively heat a region of the auger housing.

8. The feed screw of claim 1, further comprising an air removal system configured to remove air trapped in the depolymerization fluid prior to or during conveyance of the depolymerization fluid along the hollow central shaft.

9. The feed screw of claim 1, wherein the insulation material comprises at least one of a thermal insulation layer, an air gap, a coolant passage, and a rotary union feature configured to circulate a coolant selected from air, water, and oil.

10. The feed screw of claim 1, wherein the compression zone comprises a region of the auger having a reduced flight pitch relative to an upstream region to increase compression of the material.

11. The feed screw of claim 1, wherein the pre-depolymerization occurs at a discharge of the feed screw into a downstream pipe or reactor inlet such that the material begins depolymerization as it exits the feed screw.

12. A hollow shaft feed screw for feeding a material in a process, comprising:
an auger received within an auger housing and configured to rotate to convey material along the auger housing to a compression zone, the auger having a hollow central shaft;
an insulation material along an interior of the hollow central shaft of the auger; and
a pump configured to convey a high-temperature fluid along the hollow central shaft of the auger to the compression zone;
wherein the insulation material limits heat transfer from the fluid to the auger and to the material while the fluid and the material are conveyed to the compression zone.

13. The hollow shaft feed screw of claim 12, wherein the material comprises one or more materials selected from the group consisting of open cell foam and closed cell foam.

14. The hollow shaft feed screw of claim 12, wherein the high-temperature fluid comprises a breakdown fluid configured to initiate chemical or physical processing of the material.

15. The hollow shaft feed screw of claim 12, further comprising a hopper positioned to introduce the material into the auger housing upstream of the compression zone.

16. The hollow shaft feed screw of claim 12, wherein metering and feeding of the material by the auger is configured to provide a controlled mass flow rate of the material to a downstream depolymerization system.

17. A method of pre-depolymerizing a polymer material, comprising:
introducing a mixed polymer material into an auger housing of a feed screw;
rotating an auger received within the auger housing to convey the mixed polymer material along the auger housing to a compression zone, the auger having a hollow central shaft;
pumping a high-temperature depolymerization fluid along the hollow central shaft of the auger to the compression zone; and
limiting heat transfer from the depolymerization fluid to the auger and to the mixed polymer material by providing an insulation material along an interior of the hollow central shaft;
wherein the mixed polymer material contacts the depolymerization fluid in or proximate the compression zone to begin depolymerization prior to introduction into a downstream depolymerization reactor.

18. The method of claim 17, wherein the mixed polymer material comprises at least one of shredded, hammermilled, crushed, and extruded polymer particles that include dust and fines.

19. The method of claim 17, further comprising removing air from the depolymerization fluid using an air removal system before the depolymerization fluid is pumped along the hollow central shaft.

20. The method of claim 17, further comprising controlling at least one of auger rotational speed, depolymerization fluid flow rate, and heating or cooling of the auger housing to adjust a throughput and a degree of pre-depolymerization of the mixed polymer material.
